(19) United States
(12) Patent Application Publication
(10) Pub. No.: US 2007/0194205 A1
(43) Pub. Date: Aug. 23, 2007

(54) Reusable isolation joint form

(76) Inventor: Ronald Blackmon, Corona, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/347,776

(22) Filed: Feb. 6, 2006

(51) Int. Cl. B28B 7/28

(52) U.S. Cl. 249/185

(57) ABSTRACT

A re-usable form for making diamond isolation joints used in the construction of buildings is disclosed. The form is made from wood, plastic cardboard, plastic sheet, wax coated cardboard or other material that can easily be separated from concrete. The form is placed onto a footing for a column or block out and the floor is poured around the form. After the floor is cured the form is collapsed inside itself to create the void of the diamond isolation joint. The form can be re-used in another isolation joint in the same building or on future construction projects. The form can be fabricated on site in various heights and dimensions. The form is folded or collapsed to make it easier to transport and store.

### FIELD OF THE INVENTION

This invention relates to a concrete form for making isolation joints in building construction. More particularly, the concrete form is fabricated to allow it to be easily assembled into place, the concrete is poured around the form and the form is removed and available for use in another location. The form is collapsible allowing it to fold upon itself allowing for easier transportation and storage.

### BACKGROUND OF THE INVENTION

The construction or forming of diamond isolation joints today is most commonly performed by constructing a wooden form over the footing of a support column or block out. The form is then filled with sand and the floor is poured around and on top of the form. After the concrete is hardened the concrete is removed from the top of the form, the sand is removed from inside the form and the wooden form is destructively removed from the cavity. Because the form is fabricated from solid pieces of wood it must be discarded when removed. There is waste in both the time it takes to construct, set and fill the form as well as the time it takes to remove and destroy the form to clear it from the cavity. Some patents and patent applications have been filed and issued to try and improve the construction of isolation joints.

U.S. Pat. No. 5,224,313 issued Jul. 6, 1993 and Published application US2004/0045241 published Mar. 11, 2004, both by Otis P. Guillebeau disclose a form that is mounted to the pad for a roof support column or block out. While the form provides an isolation diamond shape to support a roof column or block out, the form is cast and left in the floor of the building. Leaving the form in the floor of the building is not acceptable for building code in some areas. Since the form remains in the floor the form is also not re-usable.

U.S. Pat. No. 6,513,291 issued Feb. 4, 2003 to Gilsdorf discloses a conical form for making an isolation slab for a building support column or block out. While this patent discloses an isolation form for a building column or block out the form does not make a diamond joint, and the form is cast into the concrete where it remains after the floor slab has been poured. Leaving the form in the floor of the building is not acceptable for building code in some areas. Since the form remains in the floor the form is also not re-usable.

U.S. Pat. No. 5,857,302 issued Jan. 12, 1999 to Lill discloses members that provide concrete crack control. The members are cast into and or beneath the floor of the concrete slab and provide an expansion mechanism to reduce potential cracking of the floor in a location other than the expansion or saw cut lines. While this patent discloses an isolation form for a building column or block out the form does not make a diamond joint, and the form is cast into the concrete where it remains after the floor slab has been poured. Leaving the form in the floor of the building is not acceptable for building code in some areas. Since the form remains in the floor the form is also not re-usable.

U.S. Pat. No. 4,830,543 issued May 16, 1989 to Joubert discloses a foundation support for a building. The support form is a pyramid or cone shaped component that is placed on top of a column or block out foundation and the floor is poured onto and around the form. While this patent discloses an isolation form for a building column or block out the form does not make a diamond joint, and the form is cast into the concrete where it remains after the floor slab has been poured. Leaving the form in the floor of the building is not acceptable for building code in some areas. Since the form remains in the floor the form is also not re-usable.

What is needed is a re-usable form for making diamond isolation joints. The proposed application satisfies this need by providing a form for making isolation joints that are removable from the surrounding floor and can then be re-used in another location or stored for future use.

### BRIEF SUMMARY OF THE INVENTION

It is an object of the re-usable isolation joint to provide a form that is used to make an isolation joint and then removed from the floor and used in future locations, this provides the benefits of easier construction of the forms as well as elimination of the waste that is present when wooden forms are constructed and then destructively removed from the floor slab.

It is an object of the re-usable isolation joint to provide an isolation joint that is diamond, square, rectangular, round, pentagonal, octagonal, or other shape based upon the building code or architectural requirements.

It is another object of the re-usable isolation joint to provide a form that can be manufactured at the work site to accommodate design requirements. The form is manufacturable to various heights and sizes using tools that are available at the job site.

It is another object of the re-usable isolation joint to provide a form that is foldable for a smaller storage and or transportation size. This provides a tremendous benefit over other systems that are a fixed size and contain mostly an air cavity.

It is another object of the re-usable isolation joint to provide a form that is made from plastic cardboard, wax coated cardboard or other material that resists bonding with concrete. This material is easily cut and formed at the job site to provide the form for the isolation joint.

It is another object of the re-usable isolation joint to provide a form that is made from a rigid material that is hinged to allow it to be opened to form the isolation pocket, and also hinged to pull the form away from the surrounding floor after the floor is set.

It is another object of the re-usable isolation joint to provide a re-usable cover for the isolation joint pocket that allows the cavity to be covered and reduce intrusion of concrete into the interior of the isolation pocket form.

It is another object of the re-usable isolation joint to provide a block out to control irregular cracking around the column or block out.

It is still another object of the re-usable isolation joint to provide a form that is collapsible into itself to make removal of the form from the surrounding floor easier.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows an isometric view of a building construction site showing where the isolation form is used.

FIG. 2 shows an isometric cross sectional view of the form for an isolation joint.

FIG. 3 shows a hinged form that forms the isolation joint pocket.

FIG. 4 shows a semi-rigid form that forms the isolation joint pocket.

FIGS. 5a-5d shows the steps involved in using the isolation joint form.

### DETAILED DESCRIPTION

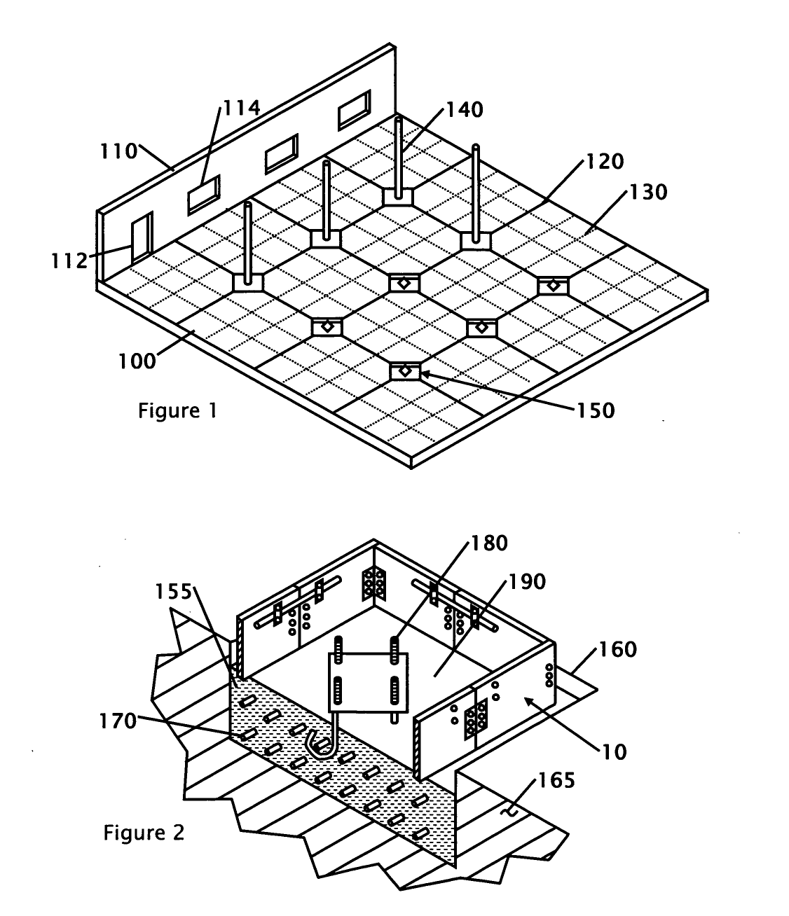

Referring to FIG. 1 that shows an isometric view of a building construction site showing where the isolation form is used. This figure shows a typical floor 100 with a wall section 110 installed on one side of the floor. Columns 140 are shown inside of the diamond isolation joint pocket 150. The columns 140 support the roof structure or any upper floor sections (not shown). Because of the weight that exists in the roof or upper floors a footing must be poured under the columns to support the weight. The description of the footing and the use of the form for the diamond isolation joint are described in more detail with FIGS. 2-5. Typically the footings that exist under the floor 100 are excavated and poured prior to pouring the floor slab. Due to the separate footing pour under the floor as well as the need for expansion and movement, the concrete at the support columns is poured separately from the footing and the floor, so it can move semi-independently from the floor. The expansion joint is also constructed with expansion joints 120 that connect each of the isolation pockets as well as the ends of the slab. The expansion joints 120 are typically spaced about 30 feet apart. The concrete is also typically saw-cut 130 at intervals between the 30 foot joints at 10 to 15 foot intervals 130. The saw cut lines provide pre-defined crack/ expansion locations for the concrete sections to expand and or move. After the floor is formed the wall 110 is poured and lifted or built into position. The wall can include one or more door openings 112 and one or more window openings 114.

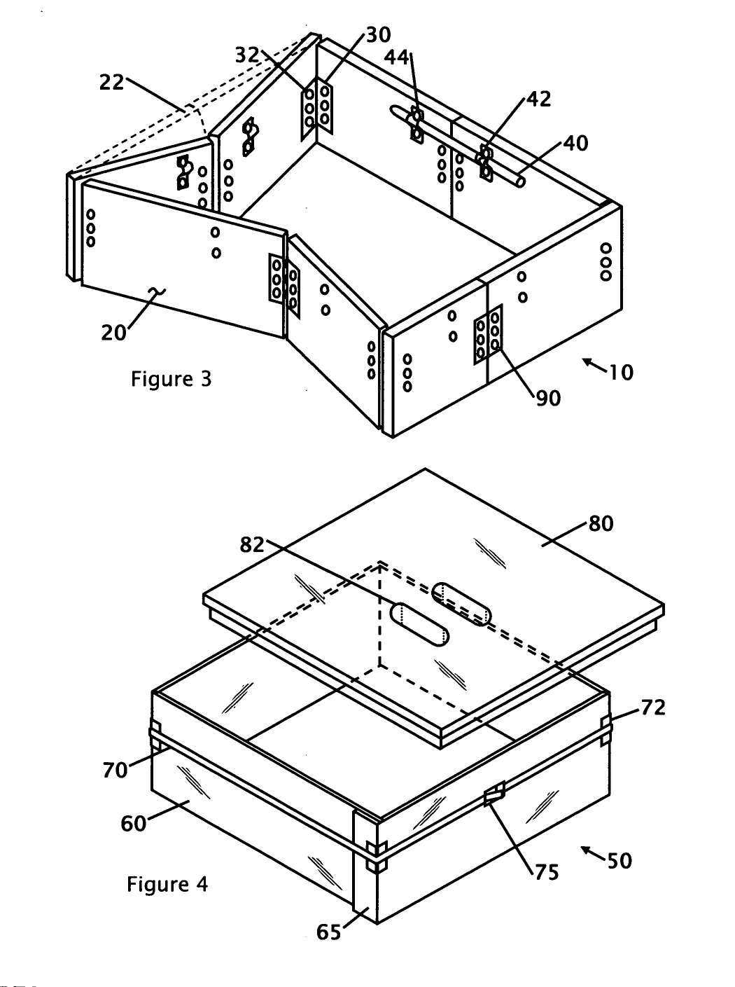

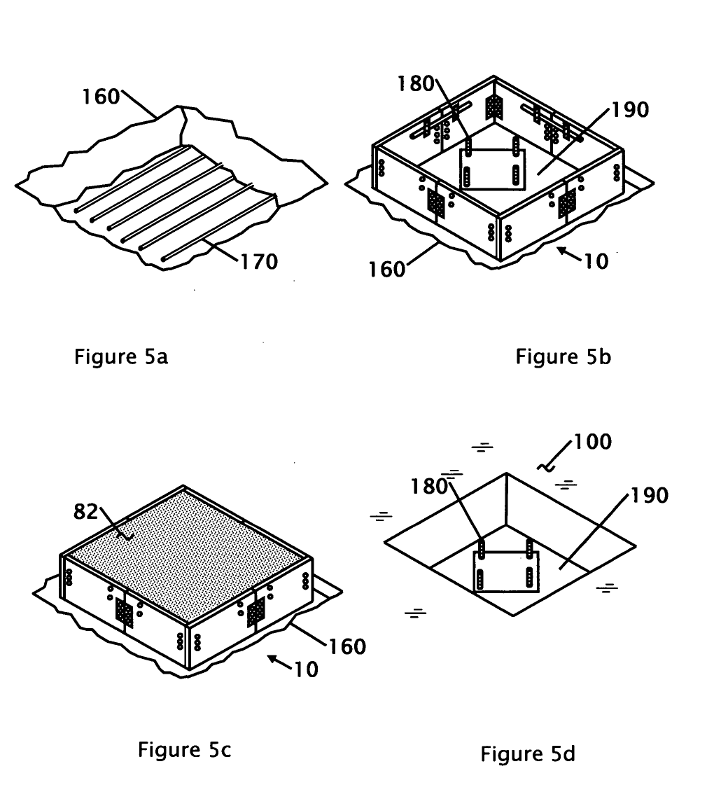

Referring to FIG. 2 that shows an isometric cross sectional view of the form for an isolation joint. The form 10 is shown here placed on top of footing 155 that is poured into the excavation hole 160. The footing hole is dug and spaced in accordance with the building plans, structural requirements and building code. The footing 155 is poured into hole 160 that is dug into the ground 165 and the footing is poured to a depth that places the top of the footing below the surrounding ground. The footing 155 typically includes rebar pieces 170 that increase the tensile strength of the concrete 155. Anchors 180 are typically placed into and or around the rebar members 170. The anchors provide a mounting for the columns as shown in FIG. 1. A space or holding plate 190 keeps the anchors in place while the concrete footing 155 hardens to ensure that the anchors are in the correct position and orientation after the concrete footing hardens or sets. The form 10 is located atop the footing prior to pouring the floor. The construction of the form 10 is shown and described in more detail in FIG. 3 and another contemplated embodiment is shown and described in FIG. 4. Additional description of using the form is described in FIG. 5.

In the preferred embodiment the isolation joint form is in the shape of a diamond, but other shapes are contemplated including but not limited to round, triangular, square, rectangular, trapezoidal, parallelogram, pentagonal, hexagonal or polygonal. The dimensions of the diamond isolation joint are usually specified in the design plans of the building and the outside dimensions are usually 24, 30 or 36 inches across but other dimensions and configurations are contemplated. The height of the diamond isolation joint is also specified in the plans for the building but is typically 6 to 24 inches in height. When the diamond isolation joint form is used the top of the form is typically placed about 2 inches below the top of the finished floor height.

Referring to FIG. 3 that shows a hinged form that forms the isolation joint pocket. In this preferred embodiment the form is constructed from a plastic, wood, pressed wood or manufactured wood that is not significantly affected by water or concrete. Each side 20 of the form 10 is made from two pieces that are hinged 90 in the center. The center hinge(s) allow the sides 22 of the form to be collapsed inward to pull them away from the poured and set concrete that is poured around the form. Hinge(s) 30 are placed on the corners of the form that operate with the center hinges 90 to collapse the form into the concrete poured around the isolation joint. Hardware such as screws or other similar fastening means 32 secure the hinges to the form. When the sides of the form are straightened a rod 40 is placed through “U” clips 42 that keep the sides of the form in an essentially straight configuration. The rods maintain the sides straight as the concrete is poured around the form and pushed in on the sides of the form. Another typical method of maintaining the sides of the form in a straight condition is fill the inside of the form with an expendable material such as sand or other material that is removed from the inside of the form after concrete is poured around the form. Hardware such as screws 44 or other similar fastening means secure the “U” clips to the form. In another contemplated embodiment the rods are replaced with latched, clasps or clamp the pull on the opposing sides of the center hinge(s) 90 to maintain the sides of the form in a straight orientation.

With all the rods removed the form can be folded in upon itself to form a flat shape that can be easily transported and stored. Because the form folds in upon itself it is not destroyed upon removal from the surrounding concrete floor. After storage or transportation the form can be re-used to make future or subsequent isolation joint pockets.

Referring to FIG. 4 that shows a semi-rigid form that forms the isolation joint pocket. This preferred embodiment of the isolation joint form 50 is constructed from a pliable material where the walls can be flexed towards the inside of the isolation pocket to remove the form from the surrounding concrete. The form is preferably made from plastic cardboard or wax coated cardboard but other equivalent materials are contemplated that do not bond with the concrete or degrade from contact with water or concrete. In the preferred embodiment the form 50 is constructed from a sheet of material that is cut to the desired height and folded to make the diamond shape. In the preferred embodiment the isolation joint form is in the shape of a diamond, but other shapes are contemplated including but not limited to round, triangular, square, rectangular, trapezoidal, parallelogram, pentagonal, hexagonal or polygonal. The walls in the preferred embodiment are straight and perpendicular, but it is further contemplated that the side walls can be angled inward or outward creating a draft angle to more easily allow the form to be removed from the concrete poured and set around the form.

The dimensions of the diamond isolation joint are usually specified in the design plans of the building and the outside dimensions are usually 24, 30 or 36 inches across but other dimensions and configurations are contemplated. The height of the diamond isolation joint is also usually specified in the plans for the building but is typically 6 to 24 inches in height. When the diamond isolation joint form is used the top of the form is typically placed about 2 inches below the top of the finished floor height. A standard 4 foot by 8 foot sheet of material will yield four 10 inch high forms that are 23½ inches on each side.

The end flap 65 of the diamond isolation form wrapped over one side 60 of the form. Plastic or metal strapping material 70 is wrapped around the form to keep the form in a diamond shape. A clasp 75 or similar connecting mechanism holds the ends of the strap together. Corner protectors 72 reduce the possibility that the strap 70 will crush the corners and more evenly distributes the load of the strap 70 on the corners of the form. If the form is tall, more than one strap is used with the form. In one contemplated method of using the form, the form is filled with expendable material such as sand that is removed from within the form prior to removal of the form from the concrete poured around the form. In another contemplated embodiment a cap 80 is placed inside the form to maintain the shape of the form and eliminate the need for the sand. The cap 80 has holes or other features 82 to allow the cover to be removed from the form after the concrete has been poured and set around the form. The form is typically placed 2 inches below the finished grade, and the height of the cap is constructed such that the upper lip of the cap accommodates the 2 inches of depth. After the concrete is sufficiently cured and the sand or cap is removed the sides of the pliable form are bent inward to pull it away from the concrete and remove it from the pocket. The form is then folded transported stored and/or re-used to construct another diamond isolation pocket.

Referring to FIGS. 5a-5d that show the steps involved in using the isolation joint form. In FIG. 5a hole(s) 160 are dug in the ground to accommodate the column or block out footing. The rebar material 170 is placed within the hole. The rebar is usually placed on rebar Dobie or other spacers to keep the rebar from being cast on the dirt. The bottom of the hole may also be covered with a layer of sand or other material. Concrete is poured into the footing and threaded anchors are usually set and cast into the footing as shown in FIG. 2. After the concrete in the footing is sufficiently set the form 10 is placed on top of the footing as shown in FIG. 5b.

The footing is usually set several inches into the hole 160 below the surrounding ground. A locating spacer plate 190 maintains the location of the anchors 180 in the footing. FIG. 5c shows the isolation diamond joint form 10 in the hole 160, with sand 82 filling the inside of the form. At this stage the concrete floor can be poured around and on top of the form 10.

After the concrete floor 100 is poured the concrete over the form is broken away, the sand or other expendable material 82 is removed from within the form, and the form is collapsed into the center of the pocket for removal, transportation, storage or to be used to form another isolation joint. The locating spacer plate 190 maintains the location of the anchors 180 in the footing. A future pour of concrete fills the void with or without the column attached to the threaded ends of the anchors.

In the embodiment including the cap 80 as shown and described in FIG. 4, the pocket is not filled with expendable material 82, and the cap is removed providing an open pocket where removal of the form is simplified.

With all the rods removed the form can be folded upon itself to form a flat shape that can be easily transported and stored. Because the form folds in upon itself it is not destroyed upon removal from the surrounding concrete floor. After storage or transportation the form can be re-used to make future or subsequent isolation joints.

Thus, specific embodiments of a re-usable form for making isolation joints have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A re-usable form for making isolation joints comprising:
a multi-sided thin wall structure forming a closed cavity that prevents the intrusion of concrete that is poured around the structure from significantly intruding within the structure;
where the structure is used to create an isolation pocket in a concrete floor wherein the structure is removable from within the concrete poured around the structure by collapsing the structure within the cavity, and
the majority of the structure is re-usable at a future location.

2. The re-usable form for making isolation joints from claim 1 wherein the closed cavity is round, triangular, square, diamond, rectangular, trapezoidal, parallelogram, pentagonal, hexagonal or polygonal.

3. The re-usable form for making isolation joints from claim 1 wherein the walls of the multi-sided thin wall structure are vertical or angled inward or outward.

4. The re-usable form for making isolation joints from claim 1 wherein the structure is used upon a concrete footing.

5. The re-usable form for making isolation joints from claim 1 wherein the structure is made essentially from plastic cardboard, plastic, or wax coated cardboard, plastic, wood, pressed wood or manufactured wood.

6. The re-usable form for making isolation joints from claim 1 that further includes hinges placed on the corners and mid-span from the corners to allow the structure to collapse within the cavity.

7. The re-usable form for making isolation joints from claim 1 that further includes a cover that essentially encloses the top of the cavity.

8. The re-usable form for making isolation joints from claim 1 wherein the structure can be folded upon itself to form a flattened unit.

9. The re-usable form for making isolation joints from claim 1 that further includes a method of using the structure comprising;
setting the form on a column or block out footing;
filling the form with expendable material;
pouring concrete around the form;
removing the expendable material from within the form, and
removing the form from within the concrete.

10. The re-usable form for making isolation joints from claim 1 wherein collapsing the structure within the cavity comprises flexing or bending at least one side of the form into the center of the structure thus allowing the remaining sides to move away from the concrete that has hardened.

11. A pliable form for making isolation joints comprising:
a vertical walled structure made from pliable material forming an open cavity that creates an isolation pocket in the floor of a building when concrete is poured around the structure;
the vertical walled structure is removable from within the concrete poured around the structure by flexing the structure to collapse the structure within the cavity, and
after removal of the vertically walled structure the vertical walled structure is usable to form subsequent open pockets.

12. The pliable form for making isolation joints from claim 11 wherein the closed cavity is round, triangular, square, diamond, rectangular, trapezoidal, parallelogram, pentagonal, hexagonal or polygonal.

13. The pliable form for making isolation joints from claim 11 wherein the walls of the multi-sided thin wall structure are vertical or angled inward or outward.

14. The pliable form for making isolation joints from claim 11 wherein the structure is used upon a concrete footing.

15. The pliable form for making isolation joints from claim 11 wherein the structure is made essentially from plastic cardboard, plastic, or wax coated cardboard, plastic, wood, pressed wood or manufactured wood.

16. The pliable form for making isolation joints from claim 11 that further includes hinges placed on the corners and mid-span from the corners to allow the structure to collapse within the cavity.

17. The pliable form for making isolation joints from claim 11 that further includes a cover that essentially encloses the top of the cavity.

18. The pliable form for making isolation joints from claim 11 wherein the structure can be folded upon itself to form a flattened unit.

19. The pliable form for making isolation joints from claim 11 that further includes a method of using the structure comprising;
setting the form on a column or block out footing;
filling the form with expendable material;
pouring concrete around the form;
removing the expendable material from within the form, and
removing the form from within the concrete.

20. The pliable form for making isolation joints from claim 11 wherein collapsing the structure within the cavity comprises flexing or bending at least one side of the form into the center of the structure thus allowing the remaining sides to move away from the concrete that has hardened.
